(19) United States
(12) Patent Application Publication
(10) Pub. No.: US 2010/0246225 A1
(43) Pub. Date: Sep. 30, 2010

(54) POWER SUPPLY FOR SERVER

(75) Inventors: Gun Woo MOON, Daejeon-si (KR); Don Sik KIM, Gunpo-si (KR); Kyu Min CHO, Daejeon-si (KR); Young Do KIM, Daejeon-si (KR); Dae Min JANG, Anyang-si (KR); Chong Eun KIM, Daejeon-si (KR); Jong Pil KIM, Gwacheon-si (KR); Dong Joong KIM, Suwon-si (KR); Tae Won HEO, Suwon-si (KR); Sang Cheol BONG, Suwon-si (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon-si (KR)

(21) Appl. No.: 12/648,702

(22) Filed: Dec. 29, 2009

(30) Foreign Application Priority Data
Mar. 31, 2009 (KR) 10-2009-0027220

(51) Int. Cl. H02M 7/219

(52) U.S. Cl. 363/124

(57) ABSTRACT

The present invention provides a power supply for a server including: a PFC (Power Factor Correction) unit for meeting harmonic regulation by being connected to an input power source; a DC/DC unit including a switching stage provided with at least one switching device to switch a voltage of a link capacitor as an output voltage of the PFC unit to a predetermined operation frequency and a DC/DC stage driven by the switching stage; a DC/DC control unit for controlling the DC/DC unit by being connected to the switching device; and a frequency varying circuit unit for supplying the DC/DC control unit with a frequency control signal to adjust the operation frequency of the switching device according to load after detecting an output current of the link capacitor and acquiring load information.

### CROSS-REFERENCE TO RELATED APPLICATIONS

This application claims the benefit of Korean Patent Application No. 10-2009-0027220 filed with the Korea Intellectual Property Office on Mar. 31, 2009, the disclosure of which is incorporated herein by reference.

### BACKGROUND OF THE INVENTION

1. Field of the Invention

The present invention relates to a power supply for a server; and, more particularly, to a power supply for a server capable of varying an operation frequency of a switching stage according to load after acquiring load information through an output current of a link capacitor.

2. Description of the Related Art

A distributed power system such as a power supply for a server consists of a PFC (Power Factor Correction) for meeting harmonic regulation and a DC/DC unit for generating a bus voltage of the system.

A recent trend is that output specification of low voltage and large current is required as output of the DC/DC unit. As functions of processors driven at a low voltage are increased in order to reduce power consumption of communication devices and the processors, power consumption of each of the processors is increased. As a result, most of DC/DC units have output specification of low voltage and large current.

In a state of high power having output of low voltage and large current, the DC/DC unit is reduced in a duty ratio and is increased in an effective current value if an operation frequency is increased, thereby increasing conduction loss of a device. Therefore, the DC/DC unit was designed until now so that the operation frequency operates in a low region in consideration of a saturation state of a magnetic device in order to improve efficiency.

Although as load of the DC/DC unit is reduced to light load, the entire conduction loss is reduced, core loss is uniformly maintained with little change. Therefore, most of loss is occupied by the core loss of a transformer in the light load due to the low operation frequency of the DC/DC unit.

In other words, in the state of high power, the conventional DC/DC unit was driven at the low operation frequency in the maximum load condition to improve efficiency. However, excessive core loss of the transformer is caused due to the low operation frequency in the light load where the conduction loss occupies a small portion of the entire loss, thereby reducing the efficiency.

### SUMMARY OF THE INVENTION

The present invention has been proposed in order to overcome the above-described problems and it is, therefore, an object of the present invention to provide a power supply for a server to operate an operation frequency of a switching stage at an operation frequency higher than a predetermined operation frequency in the case of light load after acquiring load information through an output current of a link capacitor.

In accordance with one aspect of the present invention to achieve the object, there is provided a power supply for a server including: a PFC (Power Factor Correction) unit for meeting harmonic regulation by being connected to an input power source; a DC/DC unit including a switching stage provided with at least one switching device to switch a voltage of a link capacitor as an output voltage of the PFC unit to a predetermined operation frequency and a DC/DC stage driven by the switching stage; a DC/DC control unit for controlling the DC/DC unit by being connected to the switching device; and a frequency varying circuit unit for supplying the DC/DC control unit with a frequency control signal to adjust the operation frequency of the switching device according to load after detecting an output current of the link capacitor and acquiring load information.

The PFC unit includes a boost converter.

The switching device is a switching transistor.

The DC/DC stage includes a PSFB (Phase Shift Full Bridge Converter).

The frequency varying circuit unit includes a current detector for detecting the output current of the link capacitor; a low-pass filter for removing noise of the output current detected by the current detector; and a variable controller for generating a frequency control signal to adjust the operation frequency of the switching device to operate at an operation frequency higher than a predetermined operation frequency and applying the frequency control signal to the DC/DC control unit in the case of light load after amplifying a signal passing through the low-pass filter and acquiring load information from the amplified signal.

The current detector includes a first coil positioned between the link capacitor and the switching stage; a second coil coupled with the first coil; a first diode of which an anode is connected to one end of the second coil; a second diode of which an anode is grounded and a cathode is connected to a cathode of the first diode; and a first resistor of which one end is connected to a node between the cathode of the first diode and the cathode of the second diode and the other end is grounded.

The low-pass filter includes an OP-AMP (OPerational-AMPlifier) including a positive input terminal, a negative input terminal and an output terminal; a first resistor of which one end is connected to the positive input terminal; a second resistor of which one end is connected to the other end of the first resistor and the other end is connected to the current detector; a first capacitor of which one end is connected to a node between the positive input terminal and the one end of the first resistor and the other end is grounded; and a second capacitor of which one end is connected to a node between the other end of the first resistor and the one end of the second resistor and the other end is connected to the output terminal, wherein the negative input terminal is connected to a node between the output terminal and the other end of the second capacitor.

The variable controller includes an OP-AMP including a positive input terminal, a negative input terminal, and an output terminal; a first resistor of which one end is connected to the positive input terminal and the other end is connected to the low-pass filter; a second resistor of which one end is connected to an OP-AMP driving power source; a third resistor of which one end is connected to the other end of the second resistor and the other end is grounded; a fourth resistor of which one end is connected to a node between the other end of the second resistor and the one end of the third resistor and the other end is connected to the negative input terminal; a fifth resistor of which one end is connected to a node between the negative input terminal and the other end of the fourth resistor and the other end is connected to the output terminal; and a first capacitor connected to the fifth resistor in parallel.

In accordance with another aspect of the present invention to achieve the object, there is provided a power supply for a server including: an input filter for removing high frequency noise by being connected to an input power source; a rectification unit for rectifying an AC voltage passing through the input filter; a PFC (Power Factor Correction) unit for meeting harmonic regulation by being connected to the rectification unit; a DC/DC unit including a switching stage provided with at least one switching transistor to switch a voltage of a link capacitor as an output voltage of the PFC unit to a predetermined operation frequency and a DC/DC stage driven by the switching stage; a DC/DC control unit for controlling the DC/DC unit by being connected to the switching transistor; a current detector for detecting an output current of the link capacitor; a low-pass filter for removing noise of the output current detected by the current detector; and a variable controller for generating a frequency control signal to adjust the operation frequency of the switching transistor to operate at an operation frequency higher than a predetermined operation frequency and applying the frequency control signal to the DC/DC control unit in the case of light load after amplifying a signal passing through the low-pass filter and acquiring load information from the amplified signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a power supply for a server in accordance with the present invention;

FIG. 2 is a circuit diagram of a current detector in accordance with one embodiment of the present invention;

FIG. 3 is a circuit diagram of a low pass-filter in accordance with one embodiment of the present invention;

FIG. 4 is a circuit diagram of a variable controller in accordance with one embodiment of the present invention; and

FIG. 5(a) is a graph showing operation frequencies and core loss according to load of a conventional power supply for a server and FIG. 5(b) is a graph showing operation frequencies and core loss according to load of a power supply of a server in accordance with one embodiment of the present invention.

### DETAILED DESCRIPTION OF THE PREFERABLE EMBODIMENTS

The present invention may include several embodiments through various modifications, wherein specific embodiments are exemplified in the accompanying drawings and will be explained in detail, hereinafter. However, it should be understood that the present invention is not limited to the specific embodiments and includes all modifications, equivalents and substitutions falling within the spirit and technical scope of the present invention. In description of the present invention, if it is determined that detailed description of related published techniques makes the gist of the present invention vague, the detailed description thereof will be omitted.

Although terms such as “first” and “second” may be used in order to describe various components, the components should not be limited by the terms. The terms are used only to distinguish one component from the other components.

The terms of this application are used only to describe the specific embodiments, but they are not aimed at limiting the present invention. A singular form includes a plural form as long as the singular form does not clearly indicate a different thing from the plural form. It should be understood that in this application, terms such as “include” or “have” specify existence of a characteristic, a figure, a step, an operation, a component, a part or a combination thereof which are described in the specification but do not previously exclude existence or possibility of addition of one or more different characteristics, figures, steps, operations, components, parts or combinations thereof.

Hereinafter, embodiments of a power supply for a server in accordance with the present invention will be described in detail with reference to the accompanying drawings. In describing them with reference to the accompanying drawings, the same or corresponding component will be represented by the same reference numeral and repeated description thereof will be omitted.

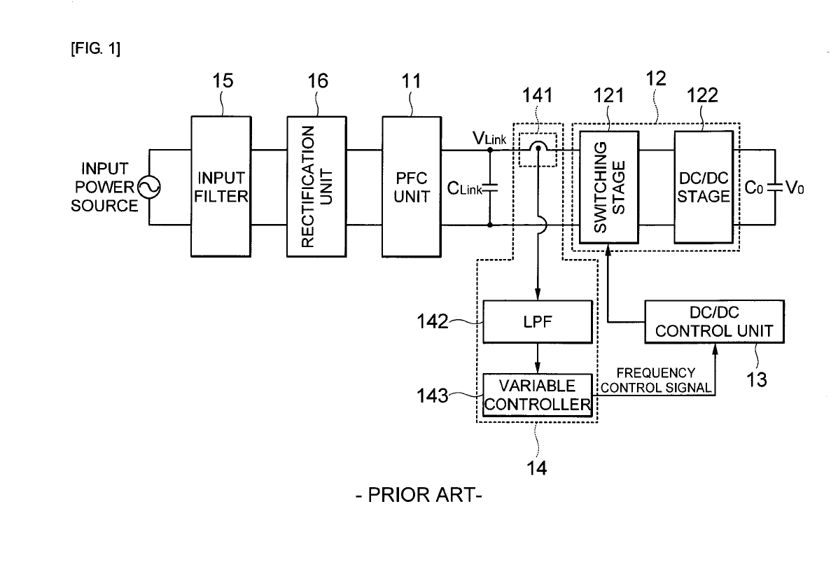

FIG. 1 is a view illustrating a power supply for a server in accordance with the present invention.

Referring to FIG. 1, in accordance with one embodiment of the present invention, the power supply for the server includes a PFC (Power Factor Correction) unit 11, a DC/DC unit 12, a DC/DC control unit 13, and a frequency varying circuit unit 14.

The PFC unit 11 meets harmonic regulation by being connected to an input power source. Since the PFC unit 11 generally includes a boost converter, a link capacitor has always a voltage higher than the maximum of a voltage of an input line in order to satisfactorily operate the PFC unit 11. As for general commercial AC power, 85Vac to 265Vac are used and peak voltages of them are 120.2V to 374.8V. Therefore, as for the voltage of the link capacitor, 380Vac to 400Vac are generally used in consideration of a withstand voltage of the capacitor.

The DC/DC unit 12 includes a switching stage 121 and a DC/DC stage 122.

The switching stage 121 has at least one switching device and can switch the voltage of the link capacitor as an output voltage of the PFC unit 11 to a predetermined operation frequency.

At this time, the switching device may be a switching transistor.

The DC/DC stage 122 may be driven by the switching stage 121.

The DC/DC stage 122 may include a PSFB (Phase Shift Full Bridge Converter) which has a high input voltage and a wide input voltage range. The PSFB can control an output voltage by adjusting a duty ratio although voltage stress of the switching device becomes an input voltage and it has the wide input voltage range, and has a characteristic in which the stress of voltage and current is always symmetrical regardless of the duty ratio.

The DC/DC control unit 13 can control an operation frequency of the DC/DC unit or the like by being connected to the switching device of the switching stage 121.

The frequency varying circuit unit 14 can supply the DC/DC control unit 13 with a frequency control signal to adjust an operation frequency of the switching device according to load after detecting an output current of the link capacitor and acquiring load information.

Since if the output current of the link capacitor is detected, it is possible to determine a load current passing through the DC/DC stage 122 including a transformer which is connected to the link capacitor and has a uniform winding ratio, the load information can be acquired from the output current of the link capacitor.

The frequency varying circuit unit 14 includes a current detector 141, a low-pass filter 142, and a variable controller 143.

FIG. 2 is a circuit diagram of the current detector in accordance with one embodiment of the present invention.

The current detector is positioned between the link capacitor and the DC/DC unit 12 and detects the output current of the link capacitor to supply it to the low pass-filter 142.

Referring to FIG. 2, the current detector 141 in accordance with the one embodiment of the present invention includes a first coil L1, a second coil L2, a first diode D1, a second diode D2, and a first resistor R1.

The first coil L1 may be positioned between the link capacitor and the switching stage 121 and the second coil L2 may be connected by being coupled with the first coil L1.

An anode of the first diode D1 may be connected to one end of the second coil L2. Further, the other end of the second coil L2 may be connected to a ground.

An anode of the second diode D2 may be connected to the ground and a cathode thereof may be connected to a cathode of the first diode D1.

One end of the first resistor R1 may be connected to a node between the cathode of the first diode D1 and the cathode of the second diode D2 and the other end thereof may be connected to the ground.

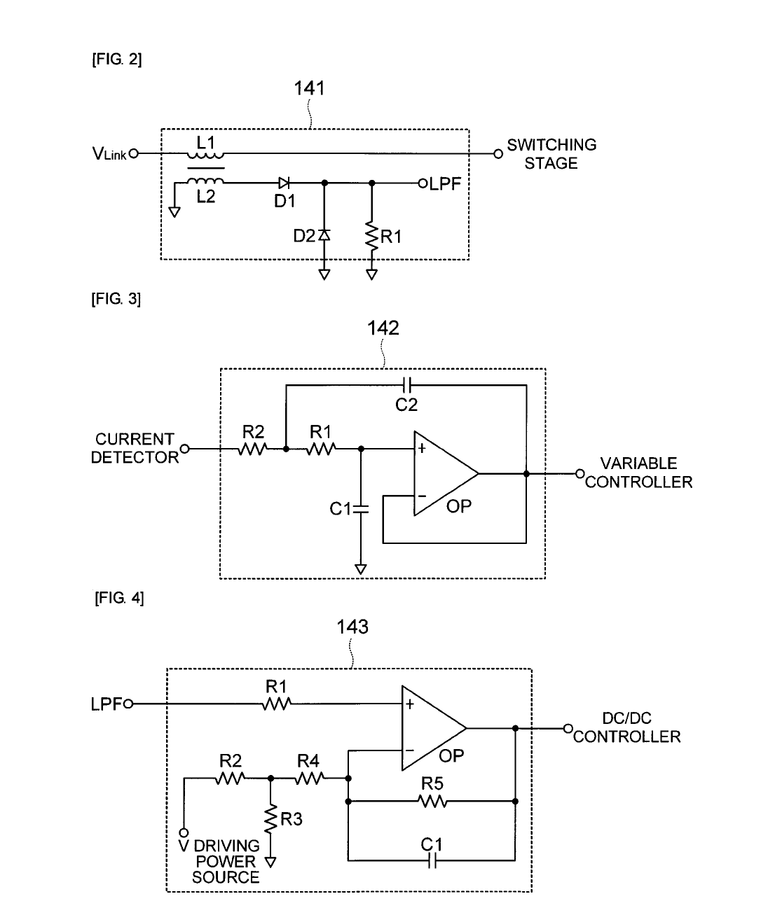

FIG. 3 is a circuit diagram of the low-pass filter in accordance with one embodiment of the present invention.

The low-pass filter 142 is positioned between the current detector 141 and the variable controller 143 and removes noise of the output current which is detected by the current detector 141.

Referring to FIG. 3, the low-pass filter 142 in accordance with the one embodiment of the present invention includes an OP-AMP (OPerational-AMPlifier) OP, a first resistor R1, a second resistor R2, a first capacitor C1, and a second capacitor C2.

The OP-AMP OP may have a positive input terminal, a negative input terminal, and an output terminal and one end of the first resistor R1 may be connected to the positive input terminal of the OP-AMP OP.

One end of the second resistor R2 may be connected to the other end of the first resistor R1 and the other end thereof may be connected to the current detector 141.

One end of the first capacitor C1 may be connected to a node between the positive input terminal of the OP-AMP OP and the one end of the first resistor R1 and the other end thereof may be connected to the ground.

One end of the second capacitor C2 may be connected to a node between the other end of the first resistor R1 and the one end of the second resistor R2 and the other end thereof may be connected to the output terminal of the OP-AMP OP.

Further, the negative input terminal of the OP-AMP OP may be connected to a node between the output terminal of the OP-AMP OP and the other end of the second capacitor C2.

FIG. 4 is a circuit diagram of the variable controller in accordance with one embodiment of the present invention.

The variable controller 143 is connected to the low-pass filter 142 and can generate a frequency control signal to adjust the operation frequency of the switching device to operate at an operation frequency higher than a predetermined operation frequency in the case where load corresponds to light load after amplifying a signal passing through the low-pass filter 142 and acquiring load information from the amplified signal.

Referring to FIG. 4, the variable controller 143 in accordance with the one embodiment of the present invention includes an OP-AMP OP, a first resistor R1, a second resistor R2, a third resistor R3, a fourth resistor R4, a fifth resistor R5, and a first capacitor C1.

The OP-AMP OP may have a positive input terminal, a negative input terminal, and an output terminal.

One end of the first resistor R1 may be connected to the positive input terminal of the OP-AMP OP and the other end thereof may be connected to the low-pass filter 142.

One end of the second resistor R2 may be connected to a driving power source of the OP-AMP OP.

One end of the third resistor R3 may be connected to the other end of the second resistor 2 and the other end thereof may be connected to the ground.

One end of the fourth resistor R4 may be connected to a node between the other end of the second resistor R2 and the one end of the third resistor R3 and the other end thereof may be connected to the negative input terminal of the OP-AMP OP.

One end of the fifth resistor R5 may be connected to a node between the negative input terminal of the OP-AMP OP and the other end of the fourth resistor R4 and the other end thereof may be connected to the output terminal of the OP-AMP OP.

The first capacitor C1 may be connected to both ends of the fifth resistor R5 in parallel.

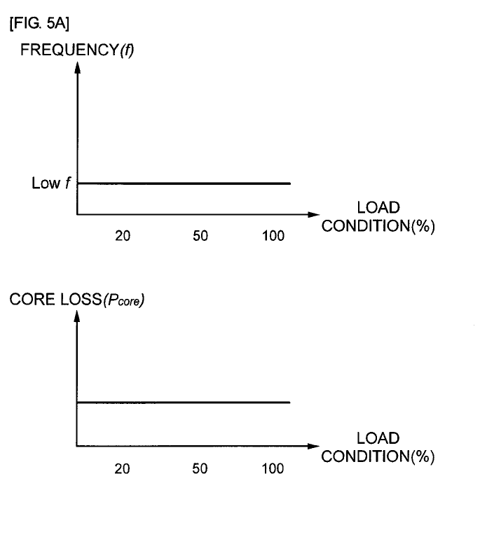

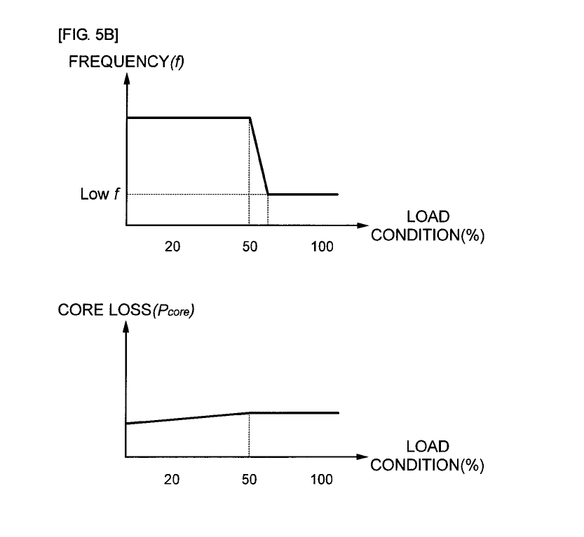

FIG. 5(a) is a graph showing operation frequencies and core loss according to load of a conventional power supply for a server and FIG. 5(b) is a graph showing operation frequencies and core loss according to load of a power supply of a server in accordance with one embodiment of the present invention.

The core loss and a magnetic flux density are expressed as the following equation.

P_{core}=A·B^{α}·f^{β}·V [Equation 1]

Herein, P_{core}, A, B, f, V, α, and β indicate the core loss, a core loss constant, a magnetic flux density, an operation frequency, a core volume, a magnetic flux density coefficient, and an operation frequency coefficient, respectively and a may be larger than 13.

That is, the core loss is in proportion to the core volume, a variation of the magnetic flux density, and the operation frequency as the equation 1.

$$Δ B = \frac{L \cdot {I}_{Lpeak}}{{A}_{e} \cdot N} \qquad [ Equation 2 ]$$

Herein, L, I_{Lpeak}, A., and N indicate inductance, the maximum current of an inductor, a cross section, and a turn ratio, respectively.

Namely, a variation of magnetic flux density is in proportion to the inductance and a peak value of current flowing through the inductor and is in inverse proportion to the cross section of the core and the turn ratio as the equation 2.

If the operation frequency of the switching stage 121 is increased, the peak value of current flowing through the inductor is reduced. Therefore, an effective value of current flowing through the inductor is reduced and the variation of the magnetic flux density also is reduced.

Further, the core loss may be reduced according to reduction of the variation of the magnetic flux density. The core loss may practically increase when the operation frequency is increased, however, since β as the operation frequency coefficient in the equation 1 has a value smaller than a as the magnetic flux density coefficient, the decrement of the core loss according to reduction of the variation of the magnetic flux density may be more than the increment of the core loss due to the operation frequency. Therefore, the entire core loss can be reduced.

As shown in FIGS. 5(a) and (b), when the operation frequency is increased in the light load, the core loss is reduced.

As described above, in accordance with the present invention, the power supply for the server can improve the efficiency by increasing the operation frequency of the switching stage in the case of light load after acquiring the load information through the output current of the link capacitor.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A power supply for a server comprising:
a PFC (Power Factor Correction) unit for meeting harmonic regulation by being connected to an input power source;
a DC/DC unit including a switching stage provided with at least one switching device to switch a voltage of a link capacitor as an output voltage of the PFC unit to a predetermined operation frequency and a DC/DC stage driven by the switching stage;
a DC/DC control unit for controlling the DC/DC unit by being connected to the switching device; and
a frequency varying circuit unit for supplying the DC/DC control unit with a frequency control signal to adjust the operation frequency of the switching device according to load after detecting an output current of the link capacitor and acquiring load information.

2. The power supply for the server of claim 1, wherein the PFC unit includes a boost converter.

3. The power supply for the server of claim 1, wherein the switching device is a switching transistor.

4. The power supply for the server of claim 1, wherein the DC/DC stage includes a PSFB (Phase Shift Full Bridge Converter).

5. The power supply for the server of claim 1, wherein the frequency varying circuit unit includes:
a current detector for detecting the output current of the link capacitor;
a low-pass filter for removing noise of the output current detected by the current detector; and
a variable controller for generating a frequency control signal to adjust the operation frequency of the switching device to operate at an operation frequency higher than a predetermined operation frequency and applying the frequency control signal to the DC/DC control unit in the case of light load after amplifying a signal passing through the low-pass filter and acquiring load information from the amplified signal.

6. The power supply for the server of claim 5, wherein the current detector includes:
a first coil positioned between the link capacitor and the switching stage;
a second coil coupled with the first coil;
a first diode of which an anode is connected to one end of the second coil;
a second diode of which an anode is grounded and a cathode is connected to a cathode of the first diode; and
a first resistor of which one end is connected to a node between the cathode of the first diode and the cathode of the second diode and the other end is grounded.

7. The power supply for the server of claim 5, wherein the low-pass filter includes:
an OP-AMP (OPerational-AMPlifier) including a positive input terminal, a negative input terminal and an output terminal;
a first resistor of which one end is connected to the positive input terminal;
a second resistor of which one end is connected to the other end of the first resistor and the other end is connected to the current detector;
a first capacitor of which one end is connected to a node between the positive input terminal and the one end of the first resistor and the other end is grounded; and
a second capacitor of which one end is connected to a node between the other end of the first resistor and the one end of the second resistor and the other end is connected to the output terminal,
wherein the negative input terminal is connected to a node between the output terminal and the other end of the second capacitor.

8. The power supply for the server of claim 5, wherein the variable controller includes:
an OP-AMP including a positive input terminal, a negative input terminal, and an output terminal;
a first resistor of which one end is connected to the positive input terminal and the other end is connected to the low-pass filter;
a second resistor of which one end is connected to an OP-AMP driving power source;
a third resistor of which one end is connected to the other end of the second resistor and the other end is grounded;
a fourth resistor of which one end is connected to a node between the other end of the second resistor and the one end of the third resistor and the other end is connected to the negative input terminal;
a fifth resistor of which one end is connected to a node between the negative input terminal and the other end of the fourth resistor and the other end is connected to the output terminal; and
a first capacitor connected to the fifth resistor in parallel.

9. A power supply for a server comprising:
an input filter for removing high frequency noise by being connected to an input power source;
a rectification unit for rectifying an AC voltage passing through the input filter;
a PFC (Power Factor Correction) unit for meeting harmonic regulation by being connected to the rectification unit;
a DC/DC unit including a switching stage provided with at least one switching transistor to switch a voltage of a link capacitor as an output voltage of the PFC unit to a predetermined operation frequency and a DC/DC stage driven by the switching stage;
a DC/DC control unit for controlling the DC/DC unit by being connected to the switching transistor;
a current detector for detecting an output current of the link capacitor;
a low-pass filter for removing noise of the output current detected by the current detector; and
a variable controller for generating a frequency control signal to adjust the operation frequency of the switching transistor to operate at an operation frequency higher than a predetermined operation frequency and applying the frequency control signal to the DC/DC control unit in the case of light load after amplifying a signal passing through the low-pass filter and acquiring load information from the amplified signal.

10. The power supply for the server of claim 9, wherein the current detector includes:
a first coil positioned between the link capacitor and the switching stage;
a second coil coupled with the first coil;
a first diode of which an anode is connected to one end of the second coil;
a second diode of which an anode is grounded and a cathode is connected to a cathode of the first diode; and
a first resistor of which one end is connected to a node between the cathode of the first diode and the cathode of the second diode and the other end is grounded.

11. The power supply for the server of claim 9, wherein the low-pass filter includes:
an OP-AMP (OPerational-AMPlifier) including a positive input terminal, a negative input terminal and an output terminal;
a first resistor of which one end is connected to the positive input terminal;
a second resistor of which one end is connected to the other end of the first resistor and the other end is connected to the current detector;
a first capacitor of which one end is connected to a node between the positive input terminal and the one end of the first resistor and the other end is grounded; and
a second capacitor of which one end is connected to a node between the other end of the first resistor and the one end of the second resistor and the other end is connected to the output terminal,
wherein the negative input terminal is connected to a node between the output terminal and the other end of the second capacitor.

12. The power supply for the server of claim 9, wherein the variable controller includes:
an OP-AMP including a positive input terminal, a negative input terminal, and an output terminal;
a first resistor of which one end is connected to the positive input terminal and the other end is connected to the low-pass filter;
a second resistor of which one end is connected to an OP-AMP driving power source;
a third resistor of which one end is connected to the other end of the second resistor and the other end is grounded;
a fourth resistor of which one end is connected to a node between the other end of the second resistor and the one end of the third resistor and the other end is connected to the negative input terminal;
a fifth resistor of which one end is connected to a node between the negative input terminal and the other end of the fourth resistor and the other end is connected to the output terminal; and
a first capacitor connected to the fifth resistor in parallel.
